(19) United States
(12) Patent Application Publication
(10) Pub. No.: US 2009/0014166 A1
(43) Pub. Date: Jan. 15, 2009

(54) SHOCK ABSORPTION FOR A LOGGING INSTRUMENT

(75) Inventor: John Cheeseborough, Spring, TX (US)

Correspondence Address: CANTOR COLBURN LLP- BAKER ATLAS, 20 Church Street, 22nd Floor, Hartford, CT, 06103, US

(73) Assignee: BAKER HUGHES INCORPORATED, Houston, TX (US)

(21) Appl. No.: 11/774,691

(22) Filed: Jul. 9, 2007

(51) Int. Cl. G01V 1/16; E21B 47/12; E21B 49/00

(52) U.S. Cl. 166/65.1; 367/188; 73/152.02

(57) ABSTRACT

A logging instrument including an instrument housing; an instrument assembly; and shock absorbing material disposed between the instrument housing and the instrument assembly to provide for absorbing shock to the instrument assembly.

### CROSS REFERENCE TO RELATED APPLICATIONS

### Background of the Invention

1. Field of the Invention

The invention disclosed herein relates to well logging instruments.

2. Description of the Related Art

In exploration for hydrocarbons, it is important to make accurate measurements of geologic formations. The geologic formations below the surface of the earth may contain reservoirs of oil and gas. The geologic formations may include formation layers and various structures. In a quest for oil and gas, it is important to know about the location and composition of the formation layers and the various structures. In particular, it is important to know about the geologic formations with a high degree of accuracy so that resources are not wasted. Measuring properties of the geologic formations provides information that can be useful for locating the reservoirs of oil and gas. Typically, the oil and gas are retrieved by drilling boreholes into the subsurface of the earth. The boreholes also provide access for taking measurements of the geologic formations.

Well logging is a technique used to take measurements of the geologic formations from the boreholes. In one embodiment, a “logging instrument” is lowered on the end of a wireline into the borehole. The logging instrument sends data via the wireline to the surface for recording. In another embodiment, the logging instrument may be dropped inside of a drill pipe without the wireline to the surface. Such a logging instrument can then be retrieved with the drill string and its data extracted at the surface. Output from the logging instrument comes in various forms and may be referred to as a “log.” Many types of measurements are made to obtain information about the geologic formations. Some examples of the measurements include gamma ray logs, nuclear magnetic resonance logs, resistivity logs, pressure logs, seismic logs, and sonic or acoustic logs. The different types of logging instruments need to survive the rigors of the environment in the borehole.

Boreholes are typically not straight but may have various curvatures. As the logging instrument traverses a borehole with various curvatures, the logging instrument may be subject to transverse accelerations or shocks in addition to axial accelerations. The logging instrument must be built to withstand the shocks or the logging instrument may lose accuracy or fail. An inaccurate or failed logging instrument can result in wasted resources.

The logging instrument can include some delicate components such as circuit boards and sensors. The logging instrument must either be built with components that can with stand the shocks or be built to protect the components from the shocks. Typically, it is less expensive in design time and money to protect the components from the shocks.

Various attempts have been made to reduce the shock experienced by the components. These attempts have focused on packaging the components into a cylindrical assembly. The assembly is then protected from the shocks with various shock absorbing devices. The diameter of the assembly must be less than the diameter of an instrument housing. The diameter of the assembly must also account for the thickness of the shock absorbing device. These attempts have resulted in some problems. For example, the volume required by the shock absorbing device subtracts from the volume available to the components. Large shock absorbing devices may result in large components being unable to fit within the assembly. Additional problems relate to maintaining the components. Maintaining the components typically requires that the assembly be disassembled. Components that are glued into the assembly may have to be unglued. Ungluing and disassembly can result in increased risk of damage to the components.

Therefore, what are needed are an apparatus and method to protect components within the logging instrument from extreme accelerations.

### BRIEF SUMMARY OF THE INVENTION

The shortcomings of the prior art are overcome and additional advantages are provided through a logging instrument including an instrument housing; an instrument assembly; and shock absorbing material disposed between the instrument housing and the instrument assembly for absorbing shock to the instrument assembly.

Also disclosed is a method for producing a logging instrument with shock protection for an instrument assembly, the logging instrument including an instrument housing, the method including selecting a shock absorbing material; placing the shock absorbing material about at least one of the instrument assembly and an interior of the instrument housing; and inserting the instrument assembly into the instrument housing, wherein the shock absorbing material is disposed between the instrument assembly and the instrument housing.

### BRIEF DESCRIPTION OF THE DRAWINGS

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 illustrates an exemplary embodiment of a logging instrument in a borehole penetrating the earth;

FIG. 2 illustrates an exemplary embodiment of the logging instrument with a shock absorbing material;

FIGS. 3A and 3B, collectively referred to as FIG. 3, depict aspects of interaction of side rails of an instrument chassis with the shock absorbing material;

FIG. 4 illustrates an exemplary embodiment of the logging instrument with axial shock protection; and

FIG. 5 illustrates an exemplary method of producing the logging instrument with the shock absorbing material.

### DETAILED DESCRIPTION OF THE INVENTION

The teachings provide for using a shock absorbing material to protect components internal to a logging instrument from accelerations or shocks. As used herein, “shock” refers to acceleration and other mechanical forces likely to cause damage to unprotected components. Shock absorbing material may be disposed between a component and the interior of an instrument housing. Shocks imposed upon an exterior surface of the instrument housing are transmitted to an interior surface of the instrument housing. At the interior surface, the shock is at least partially decreased or “absorbed” by the shock absorbing material. The shock absorbing material reduces the shock transmitted to the component.

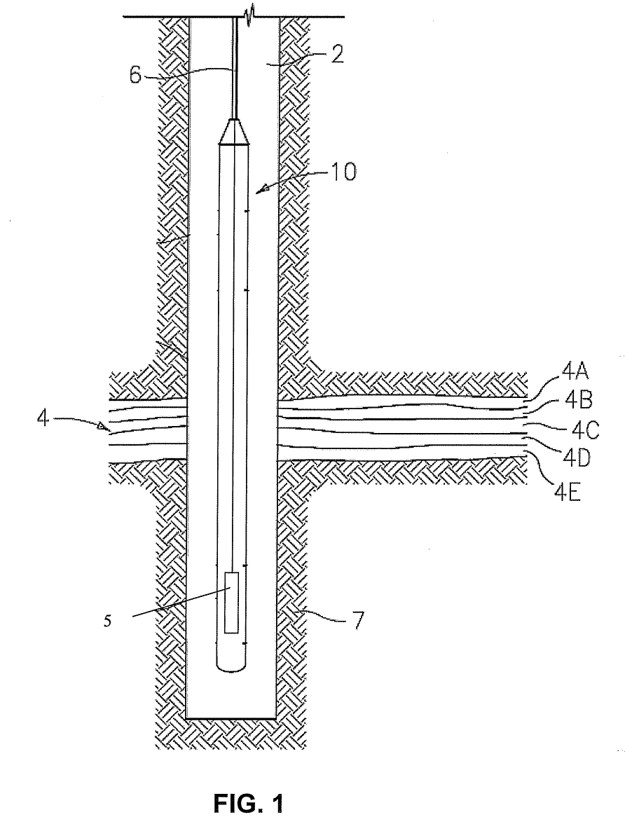

Referring to FIG. 1, a well logging instrument 10 is shown disposed in a borehole 2. The borehole 2 is drilled through earth 7 and penetrates formations 4, which include various formation layers 4A-4E. The logging instrument 10 is generally, but not always, lowered into and withdrawn from the borehole 2 by use of an armored electrical cable 6 or similar conveyance as is known in the art. An instrument assembly 5 is shown disposed within the logging instrument 10. As used herein, the instrument assembly 5 can include at least one of a chassis, electronics, wiring, and a sensor. Components such as the electronics, wiring and sensors can be secured to the chassis. The teachings provide for protecting the instrument assembly 5 from shock.

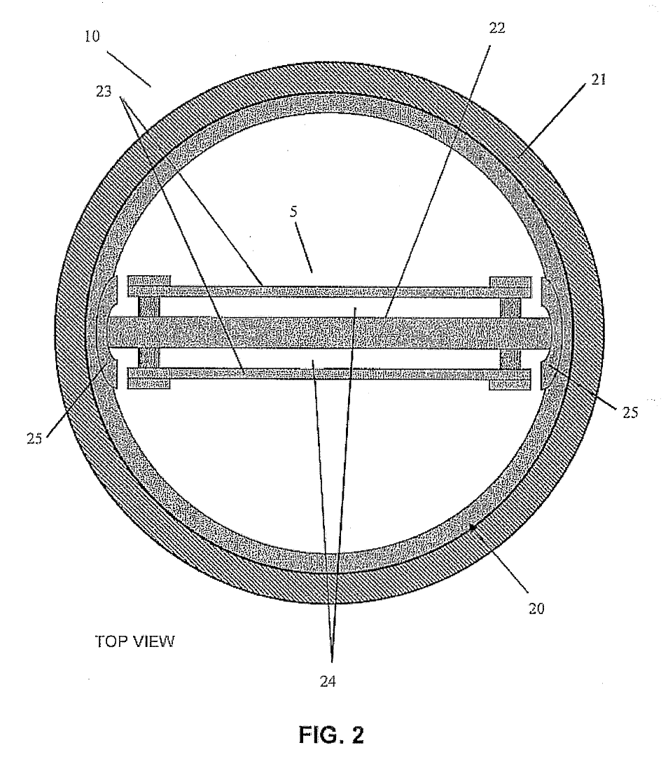

FIG. 2 illustrates an exemplary embodiment of the logging instrument 10 with the shock absorbing material. In FIG. 2, the logging instrument 10 includes an instrument housing 21 that contains the instrument assembly 5. Referring to FIG. 2, a shock absorbing material 20 is shown disposed about an interior circumference of the instrument housing 21. The instrument assembly 5 is shown disposed within a space formed interior to the shock absorbing material 20. In the embodiment shown in FIG. 2, the instrument assembly 5 is superimposed approximately upon an inside diameter of the instrument housing 21. The instrument assembly 5 includes a chassis 22, printed circuit boards 23 and wiring channels 24. The wiring channels 24 may be oriented in any or combination of three dimensions. The chassis 22 can include side rails 25 that interact with the shock absorbing material 20. The side rails 25 can be attached to the chassis 22 or formed from the chassis 22.

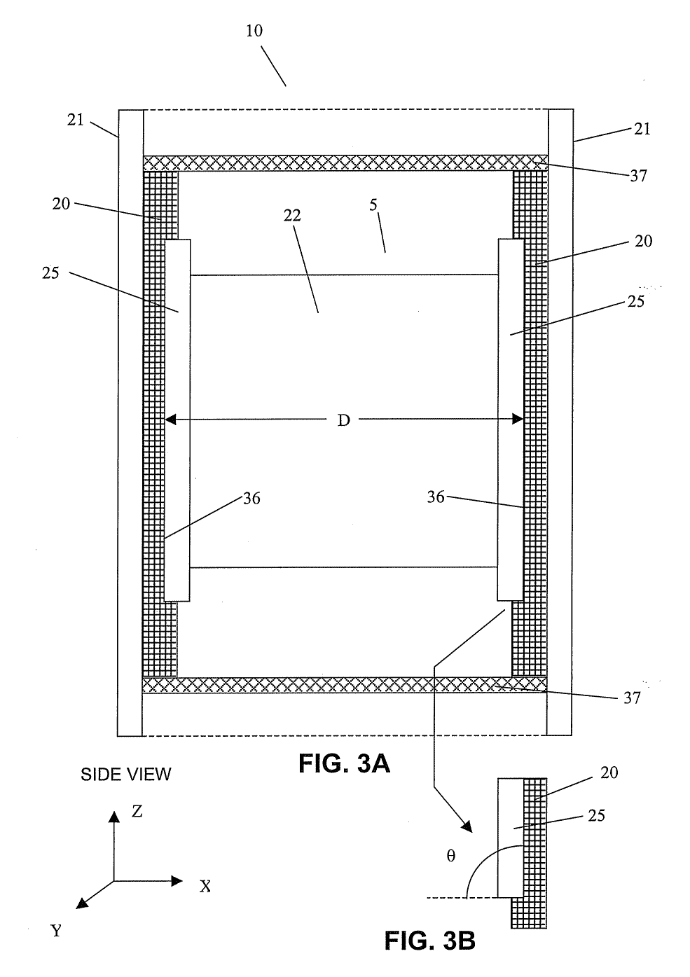

FIG. 3 depicts aspects of interaction of the side rails 25 with the shock absorbing material 20. Referring to FIG. 3A, a diameter “D” is selected to ensure that the side rails 25 compress the shock absorbing material 20. The shock absorbing material 20 is compressed an amount to provide for holding the instrument assembly 5 in place during shock producing events. Holding the instrument assembly 5 in place provides for the instrument assembly 5 not slipping with respect to the shock absorbing material 20. The side rail 25 includes at least one surface 36 that interacts with the shock absorbing material 20. The surface 36 may include a rough texture. The rough texture has a roughness that is suitable for holding the instrument assembly 5 in place during shock producing events. In other embodiments, the surface 36 may be attached to the shock absorbing material 20. Methods of attachment can include at least one of adhesive and mechanical. One example of mechanical attachment is a mechanical fastener.

FIG. 3A also illustrates a brace 37 that supports the shock absorbing material 20. The brace 37 can be derived from a shape of the instrument housing 21. The brace 37 can also be at least one of other components in the logging instrument 10 and a bracket.

FIG. 3B depicts aspects of an edge of the side rail 25 interacting with the shock absorbing material 20. Referring to FIG. 3B, an angle θ measures the angle formed by the edge of the side rail 25 with respect to the shock absorbing material 20. Generally, angles of about ninety degrees or less provide better support of the instrument assembly 5 than angles greater than about ninety degrees.

The shock absorbing material 20 can absorb shock at least one of transverse and axial to the logging instrument 10. Referring to FIG. 3A, transverse shocks are in the X-Y plane while axial shocks are parallel to the Z-axis. The transverse shocks are absorbed by compression in the X-Y plane of the shock absorbing material 20. The axial shocks are absorbed by compression of the shock absorbing material 20 parallel to the Z-axis.

In some embodiments, the shock absorbing material 20 may be attached to the interior of the instrument housing 21. In these embodiments, the axial shocks may also be absorbed by stretching of the shock absorbing material 20 in a direction parallel to the Z-axis.

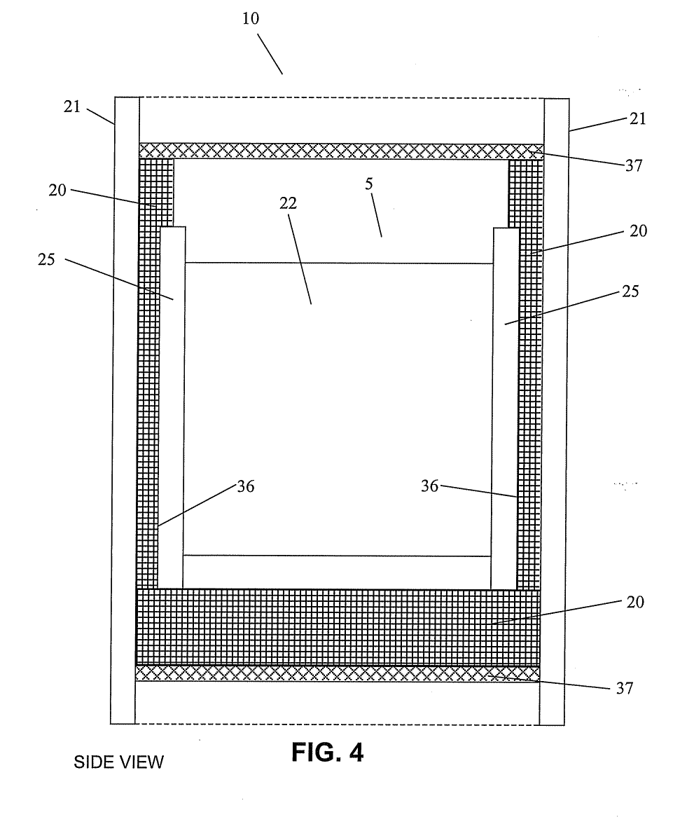

The axial shocks may also be absorbed by placing the shock absorbing material 20 at least one of above and below the chassis 22. FIG. 4 illustrates an exemplary embodiment of the shock absorbing material 20 placed below the instrument assembly 5.

Many types of material can be used for the shock absorbing material 20. An exemplary embodiment of the shock absorbing material 20 includes an expanded closed cell silicone sponge material that can endure temperatures up to about 300° C. or greater. The expanded closed cell sponge material is available from Ipotec, Inc. of Exeter, N.H. Another exemplary embodiment of the shock absorbing material 20 includes silicone sheeting that can endure temperatures up to about 260° C. or greater. The silicone sheeting is available from Rubber-Cal, Inc. of Santa Ana, Calif. The shock absorbing material 20 may be one of extruded and molded into shapes adapted for insertion into the instrument housing 21 and preventing shocks to the instrument assembly 5.

The shock absorbing material 20 can be built in several shapes. In one embodiment, the shock absorbing material 20 is in a hollow cylindrical shape. The instrument assembly 5 is inserted into the interior of the shock absorbing material 20 with the hollow cylindrical shape. The instrument assembly 5 and the shock absorbing material 20 are then inserted into the instrument housing 21. The shock absorbing material 20 is typically compressed during insertion into the instrument housing 21. In another embodiment, the shock absorbing material 20 is in a sheet form that is wrapped around the instrument assembly 5. In yet another embodiment, the shock absorbing material is in a strip form. Strips of the shock absorbing material 20 are placed about the side rails 25. The diameter D of the instrument assembly 5 and the thickness of the shock absorbing material 20 are selected so that the shock absorbing material 20 is compressed when inserted into the instrument housing 21. In a further embodiment, the shock absorbing material includes a shape that surrounds the instrument assembly 5 in three dimensions.

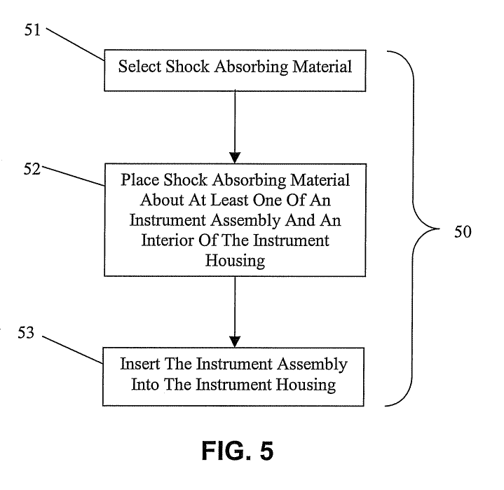

FIG. 5 illustrates an exemplary method 50 for producing the logging instrument 10 using the shock absorbing material 20 for shock absorption. A first step 51 calls for selecting the shock absorbing material 20. A second step 52 calls for placing the shock absorbing material 20 about at least one of the instrument assembly 5 and an interior of the instrument housing 21. A third step 53 calls for inserting the instrument assembly 5 into the logging instrument, wherein the shock absorbing material 20 is disposed between the instrument assembly 5 and the instrument housing 21.

Various components may be included and called upon for providing for aspects of the teachings herein. For example, a lubricant may be used to allow the shock absorbing material 20 to slide into the instrument housing 21. As another example, various brackets may be used to hold the shock absorbing material 20 in place in at least one of about the instrument assembly 5 and within the instrument housing 21. As another example, a sensor, an optical unit, an electrical unit, or electromechanical unit may be used to measure at least one of compression of the shock absorbing material 20 and displacement of the instrument assembly 5 within the logging instrument 10 to measure the shocks subjected to the instrument assembly 5. The various components may be included in support of the various aspects discussed herein or in support of other functions beyond this disclosure.

One skilled in the art will recognize that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A downhole instrument comprising:
housing;
an instrument assembly; and
shock absorbing material removably disposed between the housing and the instrument assembly for substantially an entire length of the instrument assembly.

2. The instrument as in claim 1, wherein the housing comprises a brace to support the shock absorbing material.

3. The instrument as in claim 2, wherein the housing comprises at least one of a shape, a bracket, and a component to provide the brace.

4. The instrument as in claim 1, wherein the instrument assembly comprises a side rail.

5. The instrument as in claim 4, wherein the side rail comprises a texture on a surface to prevent slipping of the assembly with respect to the shock absorbing material.

6. The instrument as in claim 4, wherein the side rail comprises an edge of about ninety degrees or less to prevent slipping of the assembly with respect to the shock absorbing material.

7. The instrument as in claim 1, wherein the shock absorbing material is attached to the instrument assembly.

8. The instrument as in claim 1, further comprising an adhesive to attach the shock absorbing material to the instrument assembly.

9. The instrument as in claim 1, further comprising a mechanical fastener to attach the shock absorbing material to the instrument assembly.

10. The instrument as in claim 1, wherein the shock absorbing material comprises a thickness to provide for compressing the shock absorbing material when the shock absorbing material and the instrument assembly are disposed in the logging instrument.

11. The instrument as in claim 1, wherein the shock absorbing material comprises at least one of silicone sheet material and expanded closed cell silicone sponge material.

12. The instrument as in claim 1, wherein the shock absorbing material is attached to the housing.

13. A method for producing a downhole instrument with shock protection for an instrument assembly, the downhole instrument comprising a housing, the method comprising:
removable placing a shock absorbing material about at least one of the instrument assembly and an interior of the housing for substantially an entire length of the instrument assembly; and
inserting the instrument assembly into the housing, wherein the shock absorbing material is disposed between the instrument assembly and the housing.

14. The method as in claim 13, wherein inserting comprises compressing the shock absorbing material.

15. The method as in claim 13, further comprising:
removing the instrument assembly from the housing;
removing the shock absorbing material from the at least one of the instrument assembly and the interior of the housing;
removably placing the shock absorbing material about at least one of the instrument assembly and the interior of the housing for substantially the entire length of the instrument assembly; and
inserting the instrument assembly into the housing, wherein the shock absorbing material is disposed between the instrument assembly and the housing.

16. A downhole instrument comprising:
a housing;
an instrument assembly; and
a material removably disposed between the housing and the instrument assembly for substantially an entire length of the instrument assembly, wherein the material at least one of compresses and stretches to reduce acceleration of the instrument assembly.
